(19) United States
(12) Patent Application Publication
(10) Pub. No.: US 2024/0085021 A1
(43) Pub. Date: Mar. 14, 2024

(54) FUEL SPRAY NOZZLE FOR GAS TURBINE ENGINE AND METHOD FOR MANUFACTURING THE SAME

(71) Applicant: Rolls-Royce plc, London (GB)

(72) Inventors: Robin WILSON, Singapore (SG); Guy STEVENSON, Derby (GB); Yue Hao CHOONG, Singapore (SG); Thaddie NATALARAY, Singapore (SG)

(73) Assignee: Rolls-Royce plc, London (GB)

(21) Appl. No.: 18/453,587

(22) Filed: Aug. 22, 2023

(30) Foreign Application Priority Data
Sep. 14, 2022 (GB) 2213412.6

(51) Int. Cl. F23R 3/28; B33Y 10/00; B33Y 80/00

(52) U.S. Cl. CPC F23R 3/28; B33Y 10/00; B33Y 80/00; F23R 2900/00018

(57) ABSTRACT

A method for manufacturing a fuel spray nozzle for a gas turbine engine includes forming a first section of the fuel spray nozzle by additive layer manufacturing. The first section includes a main chamber and internal passageways. The method includes forming a second section of the fuel spray nozzle by additive layer manufacturing on the first section. The second section includes a metering feature disposed in fluid communication with one of the internal passageways of the first section. The method includes modifying the metering feature of the second section by a first subtractive manufacturing process to obtain a desired diameter of the metering feature and/or a desired surface roughness of the metering feature. The method includes forming a third section of the fuel spray nozzle by additive layer manufacturing on the second section. The third section includes a deflector and a spin chamber.

### CROSS-REFERENCE TO RELATED APPLICATIONS

This specification is based upon and claims the benefit of priority from United Kingdom patent application number GB 2213412.6 filed on Sep. 14, 2022, the entire contents of which is incorporated herein by reference.

### BACKGROUND

### Technical Field

The present disclosure relates to a fuel spray nozzle for a gas turbine engine, and in particular to a method for manufacturing the fuel spray nozzle.

### Description of the Related Art

A gas turbine engine generally includes a fuel spray nozzle for introducing fuel into a combustor of the gas turbine engine. Specifically, the fuel is injected in the form of an atomized and precisely patterned spray to facilitate even and complete combustion within the gas turbine engine in the shortest possible time.

Conventionally, fuel spray nozzles are fabricated in sections and joined together, for example, by a brazing process. However, brazing of the multiple sections may affect a performance of the fuel spray nozzle, for example, the performance of such fuel spray nozzles may not be optimal. Further, it may be challenging to perform the brazing process on different sections of the fuel spray nozzle. Moreover, conventional fuel spray nozzles may exhibit increased propensity to coking. In some examples, fuel may deposit on walls of internal channels of the fuel spray nozzle and may block/restrict a fuel flow into the combustor, thereby deteriorating the performance of the fuel spray nozzle.

### SUMMARY

According to a first aspect, there is provided a method for manufacturing a fuel spray nozzle for a gas turbine engine. The method includes a step of forming a first section of the fuel spray nozzle by additive layer manufacturing. The first section of the fuel spray nozzle includes a main chamber and a plurality of internal passageways. The method further includes a step of forming a second section of the fuel spray nozzle by additive layer manufacturing on the first section. The second section includes at least one metering feature disposed in fluid communication with at least one of the plurality of internal passageways of the first section. The method further includes a step of modifying the at least one metering feature of the second section by a first subtractive manufacturing process to obtain a desired diameter of the at least one metering feature and/or a desired surface roughness of the at least one metering feature. The method further includes a step of forming a third section of the fuel spray nozzle by additive layer manufacturing on the second section to form the fuel spray nozzle. The third section includes a deflector and a spin chamber.

The fuel spray nozzle manufactured by the method described herein may allow formation of complex passageways within the fuel spray nozzle, thereby optimising fuel flow through the fuel spray nozzle and improving cooling performance thereof. Further, the fabrication of the fuel spray nozzle in three sections using additive layer manufacturing may enable improved and easy access to the plurality of internal passageways and the metering features. Specifically, by manufacturing the fuel spray nozzle in three stages, complex internal structures of the fuel spray nozzle may be easily accessed for the purpose of finishing the internal passages.

Further, modifying the at least one metering feature of the second section by the first subtractive manufacturing process to obtain the desired flow distribution and/or the desired surface roughness may improve atomization and mixing of fuel during operation of the gas turbine engine. Furthermore, achieving the desired surface roughness in the second section may exhibit reduced coking and may improve performance of the fuel spray nozzle. Moreover, the first subtractive manufacturing process may allow the metering features to have precise dimensions and tolerances as per application requirements.

The metering feature may be a slot, for example a slotted hole. The spin chamber may be considered a preparation zone for uniform distribution of fuel from the filming lip.

In some embodiments, the method further includes, prior to forming the second section of the fuel spray nozzle, modifying the plurality of internal passageways of the first section by a second subtractive manufacturing process to obtain a desired diameter of each of the plurality of internal passageways and/or a desired surface roughness of each of the plurality of internal passageways. Advantageously, modifying the plurality of internal passageways to obtain the desired surface roughness may reduce coking in the plurality of internal passageways. In other words, the desired surface roughness as achieved by the second subtractive manufacturing process may reduce an amount of unburnt/burnt hydrocarbons in the fuel sticking to walls defined by the internal passageways. Consequently, the durability and performance of the fuel spray nozzle may be improved, and the fuel flow through the fuel spray nozzle may be optimized. Further, the second subtractive manufacturing process may allow the internal passageways to have precise dimensions and tolerances as per application requirements.

In some embodiments, the second subtractive manufacturing process includes at least one of an abrasive flow machining process, a hydro-cavitation abrasive finishing process, and a chemical etching process. It should be noted that any known subtractive manufacturing process may be used to modify the internal passageways of the first section. As used herein, the term “subtractive manufacturing process”, unless otherwise specified, refers to any machining or material removal process known in the art.

While forming the first, second, and third sections by additive layer manufacturing, some powered dust particles or raw material may remain in the internal parts of the fuel spray nozzle, for example, the plurality of internal passageways of the first section and the metering features of the second section. Such particles may lead to early formation of coking during operation. A manufacturing of the fuel spray nozzle using the method described herein may remove such particles from the metering features and the plurality of internal passageways by the first and second subtractive manufacturing processes, respectively.

In some embodiments, the method further includes, prior to forming the second section of the fuel spray nozzle, modifying a first surface of the first section by a third subtractive manufacturing process. The second section is formed on the first surface of the first section. The third subtractive manufacturing process may present a surface (i.e., the modified first surface) having a desired surface finish on which the second section of the fuel spray nozzle may be formed.

In some embodiments, the third subtractive manufacturing process includes at least one of a milling process, a grinding process, and a burr removal process. It should be noted that any known subtractive manufacturing process may be used to modify the first surface of the first section.

In some embodiments, the method further includes, prior to forming the third section of the fuel spray nozzle, modifying a second surface of the second section by a fourth subtractive manufacturing process. The third section is formed on the second surface of the second section. The fourth subtractive manufacturing process may present a surface (i.e., the modified second surface) having a desired surface finish on which the third section of the fuel spray nozzle may be formed.

In some embodiments, the fourth subtractive manufacturing process includes at least one of a milling process, a grinding process, and a burr removal process. It should be noted that any known subtractive manufacturing process may be used to modify the second surface of the second section.

In some embodiments, the first subtractive manufacturing process includes at least one of a drilling process, a hydro-erosive grinding process, an electric discharge machining process, and a hydro-cavitation abrasive finishing process. It should be noted that any known subtractive manufacturing process may be used to modify the metering features of the second section.

According to a second aspect, there is provided a fuel spray nozzle for a gas turbine engine. The fuel spray nozzle is formed by the method of the first aspect. The fuel spray nozzle comprises: a first section that has a main chamber and a plurality of internal passageways; a second section formed on the first section, the second section comprising at least one metering feature disposed in fluid communication with at least one of the plurality of internal passageways of the first section; and a third section formed on the second section to form the fuel spray nozzle, the third section comprising a deflector and a spin chamber; wherein the fuel spray nozzle is a single unitary component with each of the first section, the second section and the third section being formed by additive layer manufacturing. Being a single unitary component means the fuel spray nozzle is a single or one-piece component albeit formed by successive additive layer manufacturing steps.

In some embodiments, the plurality of internal passageways of the first section forms a single flow circuit. Thus, the method of the first aspect may be used to manufacture fuel spray nozzles having the single flow circuit for passage of fuel, such as, simplex fuel spray nozzles.

In some embodiments, the plurality of internal passageways of the first section forms a main flow circuit and a pilot flow circuit. Thus, the method of the first aspect may be used to manufacture fuel spray nozzles having dual flow circuits, i.e., the main flow circuit and the pilot flow circuit for passage of fuel, such as, duplex fuel spray nozzles.

In some embodiments, the fuel spray nozzle further includes at least one inlet configured to receive a fuel flow. The at least one inlet is disposed in fluid communication with each of the plurality of internal passageways of the first section. The second subtractive manufacturing process may also modify the inlet of the fuel spray nozzle, so that the inlet may have a desired diameter and desired surface roughness.

According to a third aspect, there is provided a combustor for a gas turbine engine. The combustor includes the fuel spray nozzle of the second aspect.

According to a fourth aspect, there is provided a gas turbine engine including the combustor of the third aspect.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, the second compressor, and the second core shaft may be arranged to rotate at a higher rotational speed than the first core shaft.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

### DESCRIPTION OF THE DRAWINGS

Embodiments will now be described by way of example only, with reference to the Figures, in which:

FIG. 1 is a sectional side view of a gas turbine engine;

FIG. 2 is a sectional side view of a combustor associated with the gas turbine engine of FIG. 1;

FIG. 3 is a schematic perspective view of a fuel spray nozzle associated with the gas turbine engine of FIG. 1;

FIG. 4 is a schematic perspective view of a first section of the fuel spray nozzle of FIG. 3;

FIG. 5 is a schematic side view of a hydro-cavitation abrasive finishing set up including a fixture and the first section of the fuel spray nozzle of FIGS. 3 and 4;

FIG. 6 is a schematic perspective view of a second section of the fuel spray nozzle of FIG. 3;

FIG. 7 is a schematic perspective view of a hydro-erosive grinding set-up including a fixture and the first and second sections of the fuel spray nozzle of FIGS. 3 to 6;

FIG. 8 is a schematic perspective view of a third section of the fuel spray nozzle of FIGS. 3 to 6;

FIG. 9 is a sectional schematic view of a fuel spray nozzle according to a second embodiment; and

FIG. 10 is a flowchart of a method for manufacturing the fuel spray nozzle of FIGS. 3 to 8 and the fuel spray nozzle of FIG. 9;

### DETAILED DESCRIPTION

Aspects and embodiments of the present disclosure will now be discussed with reference to the accompanying figures. Further aspects and embodiments will be apparent to those skilled in the art.

As used herein, a component extends “axially” relative to an axis if the component extends along the axis. A component extends “circumferentially” relative to an axis if the component extends in a circumferential direction defined around the axis. A component extends “radially” relative to an axis if the component extends radially inward or outward relative to the axis.

As used herein, “a radially inner surface” and “a radially outer surface” of a component may be defined as an innermost, circumferentially extending surface and an outermost, circumferentially extending surface of the component, respectively, relative to the axis of rotation.

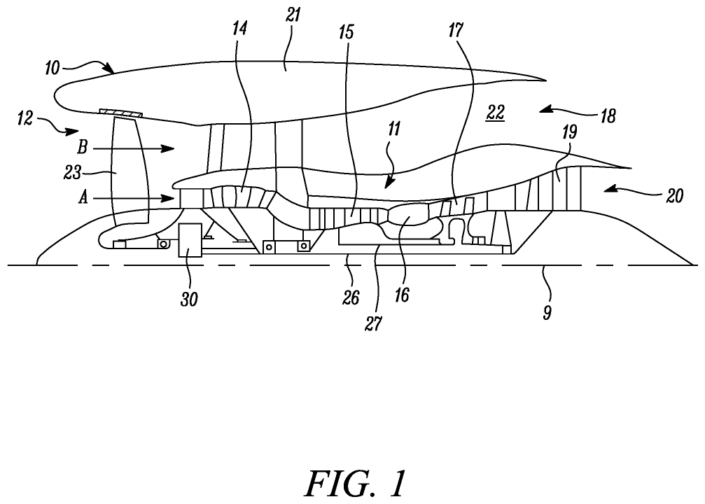

FIG. 1 illustrates a gas turbine engine 10 having a rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high pressure compressor 15, a combustion equipment 16, a high pressure turbine 17, a low pressure turbine 19, and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the core exhaust nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial, and circumferential directions are mutually perpendicular.

The present invention is equally applicable to aero gas turbine engines, marine gas turbine engines, and land-based gas turbine engines.

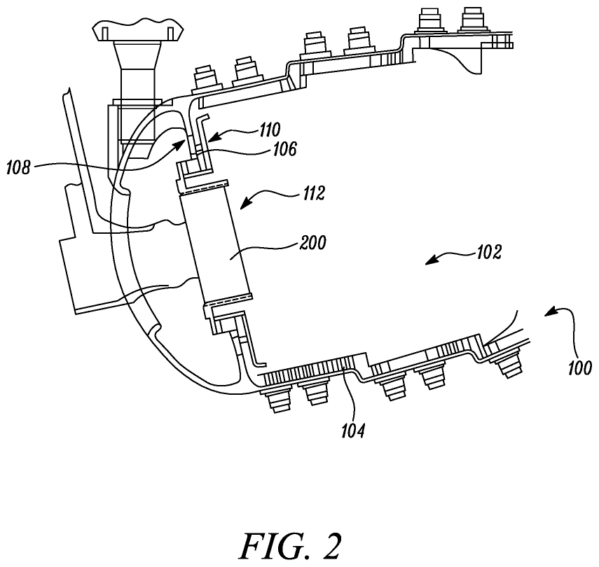

Referring to FIG. 2, the gas turbine engine 10 includes a combustor 100. FIG. 2 illustrates an exemplary embodiment of the combustor 100 for the gas turbine engine 10 of FIG. 1. The combustor 100 may define a combustion chamber 102. The combustion chamber 102 may be defined by a combustor wall 104 and an annular meter panel 106.

The meter panel 106 includes a cold side 108 and a hot side 110. The meter panel 106 is disposed proximal to the high pressure compressor 15 (see FIG. 1). The meter panel 106 has an aperture 112 extending through the meter panel 106 between the hot and cold sides 108, 110. The upstream cold side 108 faces the high pressure compressor 15 and the downstream hot side 110 faces the combustion chamber 102. The combustor 100 further includes a fuel spray nozzle 200. Specifically, the combustor 100 may include multiple fuel spray nozzles 200 (similar to the fuel spray nozzle 200). An annular location ring (not shown) may be coupled at an inside of the aperture 112 in the meter panel 106 for locating the fuel spray nozzle (FSN) 200. It should be noted that the meter panel 106 may include a number of apertures 112, such that each aperture 112 may receive a corresponding location ring, and a corresponding FSN 200 therethrough.

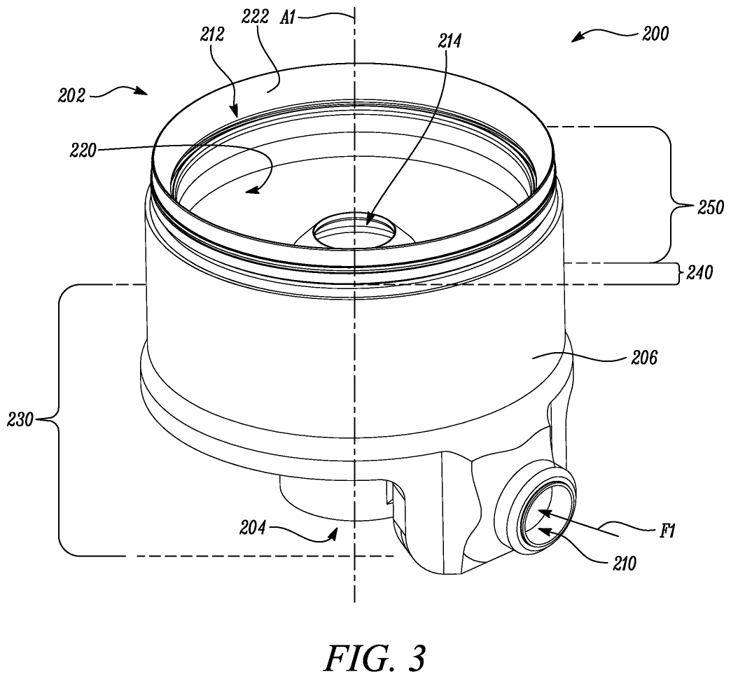

FIG. 3 illustrates a schematic perspective view of the FSN 200 for the gas turbine engine 10 (see FIG. 1). In the illustrated embodiment of FIG. 3, the FSN 200 is embodied as a pressure-swirl duplex fuel spray nozzle. The FSN 200 defines a central axis A1. The FSN 200 includes a first section 230, a second section 240, and a third section 250. Further, the FSN 200 is substantially manufactured using an additive layer manufacturing (ALM) process. The ALM process may include a three-dimensional printing process. In various examples, the ALM process may include a laser deposition process, a selective laser sintering process, a binder jet additive layer manufacturing process, a freeform fabrication process, stereolithography, and the like. It should be noted that the ALM process may include any technique of additive layer manufacturing known in the art.

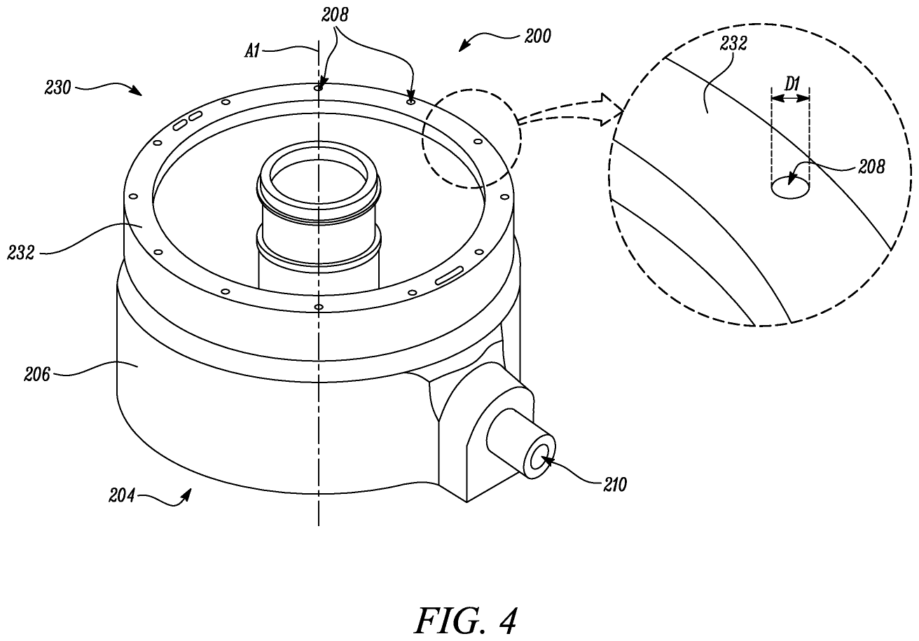

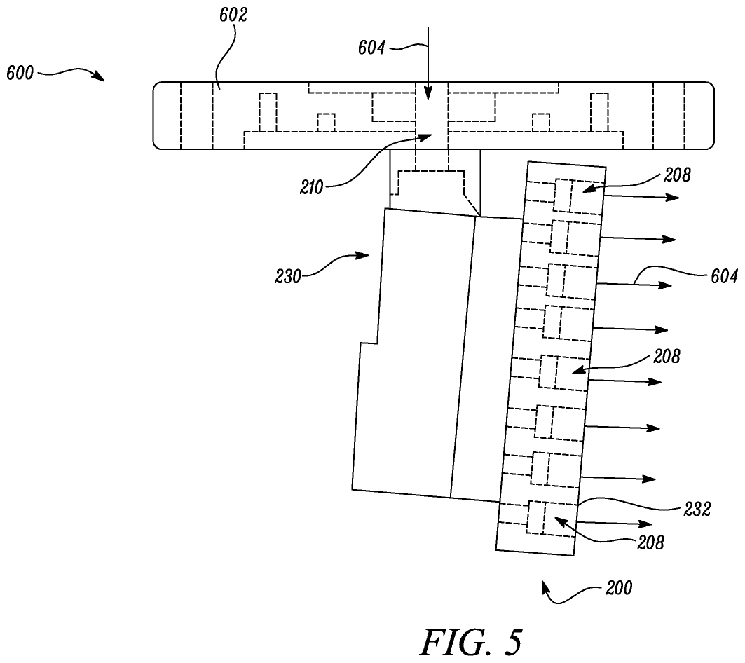

Further, the FSN 200 defines an upstream end 202 and a downstream end 204 opposite the upstream end 202. The upstream end 202 is defined proximal to the third section 250 and the downstream end 204 is defined proximal to the first section 230. Further, the first section 230 of the FSN 200 includes a main chamber 206. In the illustrated embodiment of FIG. 4, the main chamber 206 includes a cylindrical shape. The main chamber 206 extends axially along the central axis A1, from the downstream end 204 towards the upstream end 202. Further, the first section 230 also includes a plurality of internal passageways 208 (shown in FIG. 5). The term “plurality of internal passageways 208” may collectively refer to passages defined in the first section 230 that receive fuel from an inlet 210 and direct fuel towards the second section 240. The internal passageways 208 are circumferentially defined around the central axis A1. The first section 230 further includes a first surface 232 (show in FIG. 4). The second section 240 is formed on the first surface 232.

The FSN 200 further includes at least one inlet 210 configured to receive a fuel flow F1. The at least one inlet 210 is disposed proximal to the downstream end 204 of the FSN 200. Further, the at least one inlet 210 is disposed in fluid communication with each of the plurality of internal passageways 208 of the first section 230. Specifically, the internal passageways 208 extend from the inlet 210 and terminate proximal to the first surface 232 of the first section 230. In the illustrated embodiment of FIG. 3, the FSN 200 includes a single inlet 210. However, in other embodiments, the FSN 200 may include more than one inlet similar to the inlet 210.

Further, the FSN 200 includes outlets 212, 214 through which the fuel flow F1 exits the FSN 200. The outlets 212, 214 include a primary outlet 212 and a secondary outlet 214 disposed proximal to the upstream end 202 of the FSN 200. The outlet 212 may be interchangeably referred to as the primary outlet 212 and the outlet 214 may be interchangeably referred to as the secondary outlet 214. Further, the primary outlet 212 and the secondary outlet 214 are concentrically arranged about the central axis A1 of the FSN 200. Specifically, the secondary outlet 214 is concentrically disposed within the primary outlet 212.

Each of the plurality of internal passageways 208 extend from the inlet 210 towards the outlets 212, 214 (see FIG. 3). Each of the plurality of internal passageways 208 may have a desired diameter D1 (shown in FIG. 4). Further, in some embodiments, the plurality of internal passageways 208 forms a main flow circuit (not shown) and a pilot flow circuit (not shown). The fuel flow F1 entering the FSN 200 may be divided into two fuel streams, i.e., a main fuel flow and a pilot fuel flow. The main fuel flow is received within the main flow circuit and the pilot fuel flow is received within the pilot flow circuit. Further, the main fuel flow may exit the main flow circuit via the primary outlet 212 and the pilot fuel flow may exit the pilot flow circuit through the secondary outlet 214. In other embodiments, the plurality of internal passageways 208 may form a single flow circuit.

The pilot flow circuit may be used for spraying the fuel at a lower flow rate, and the main flow circuit may be used for spraying the fuel at a higher flow rate. Specifically, the pilot fuel flow may have a low flow rate, and the main fuel flow may have a high flow rate. A pressure valve (not shown) may be disposed proximal to the inlet 210 of the FSN 200. The pressure valve may separate fuel flows based on a pre-set fuel pressure.

FIG. 4 illustrates a perspective view of the first section 230 of the FSN 200. The first section 230 of the FSN 200 is formed by ALM. As illustrated, the first section 230 of the FSN 200 includes the main chamber 206 and the plurality of the internal passageways 208.

Further, in the illustrated embodiment of FIG. 4, the first surface 232 of the first section 230 is modified by a third subtractive manufacturing process prior to forming the second section 240 of the FSN 200. Specifically, the first surface 232 of the first section 230 may be modified by the third subtractive manufacturing process to obtain a desired surface roughness of the first surface 232 of the first section 230. The third subtractive manufacturing process may present a surface having a desired surface finish on which the second section 240 of the FSN 200 may be formed. In some embodiments, the third subtractive manufacturing process includes at least one of a milling process, a grinding process, and a burr removal process. In other embodiments, the third subtractive manufacturing process may include any other surface finishing process, without any limitation.

In some embodiments, the first section 230 of the FSN 200 is modified by a second subtractive manufacturing process. Specifically, the plurality of internal passageways 208 of the first section 230 may be modified by the second subtractive manufacturing process to obtain the desired diameter D1 of each of the plurality of internal passageways 208 and/or a desired surface roughness of each of the plurality of internal passageways 208. Thus, the desired diameter D1 may correspond to a diameter that may be larger than an initial diameter of each internal passageway 208 prior to the modification made by the second subtractive manufacturing process. It should be noted that the second subtractive manufacturing process may also modify a diameter of the inlet 210 and/or a desired surface roughness at the inlet 210.

Advantageously, modifying the plurality of internal passageways 208 by the second subtractive manufacturing process to obtain the desired surface roughness may reduce coking in the internal passageways 208. In other words, the surface roughness of the plurality of internal passageways 208 may be reduced by the second subtractive manufacturing process so that an amount of unburnt/burnt hydrocarbons of the fuel sticking to walls defined by the internal passageways 208 may be reduced. Further, the second subtractive manufacturing process may allow the internal passageways 208 to have precise dimensions and tolerances as per application requirements. Obtaining the desired diameter D1 of the internal passageways 208 may improve atomization and mixing of the fuel within the internal passageways 208. In some cases, if the surface roughness and the initial diameter of the internal passageways 208 after forming the first section 230 is as per requirements, the step of modifying the internal passageways 208 by the second subtractive manufacturing process may be eliminated.

In some embodiments, the second subtractive manufacturing process includes at least one of an abrasive flow machining process, a hydro-cavitation abrasive finishing (HCAF) process, and a chemical etching process. In other embodiments, the second subtractive manufacturing process may include any other material removal process, without any imitation.

An exemplary HCAF set-up 600 for performing the second subtractive manufacturing process is illustrated in FIG. 5. Specifically, the HCAF set-up 600 is used to perform the HCAF process on the first section 230. It should be noted that the HCAF process as explained herein is merely for exemplary purposes. Any other subtractive manufacturing process may be used to modify the plurality of internal passageways 208 of the first section 230 in a similar manner.

The HCAF set-up 600 includes a fixture 602. In the illustrated embodiment of FIG. 5, the fixture 602 supports and couples with the first section 230 of the FSN 200. Further, the inlet 210 of the FSN 200 is at least partially received within the fixture 602. A pressurized fluid flow 604 may be received into the inlet 210. A pressure of the fluid flow 604 may be controlled to generate cavitation bubbles (not shown) by the flow of fluid passing through surface irregularities (not shown) in the internal passageways 208. The cavitation bubbles may be continuously generated and imploded to erode a surface of the internal passageways 208. Further, the fluid flow 604 may include abrasive media to abrade the surface of the internal passageways 208. The erosion by the implosion of the cavitation bubbles and the abrasion by the abrasive media may occur simultaneously in the plurality of internal passageways 208 to obtain the desired diameter D1 (see FIG. 4) of each of the plurality of internal passageways 208 and/or the desired surface roughness of each of the plurality of internal passageways 208. Consequently, the fluid flow 604 may exit the first section 230 through the internal passageways 208.

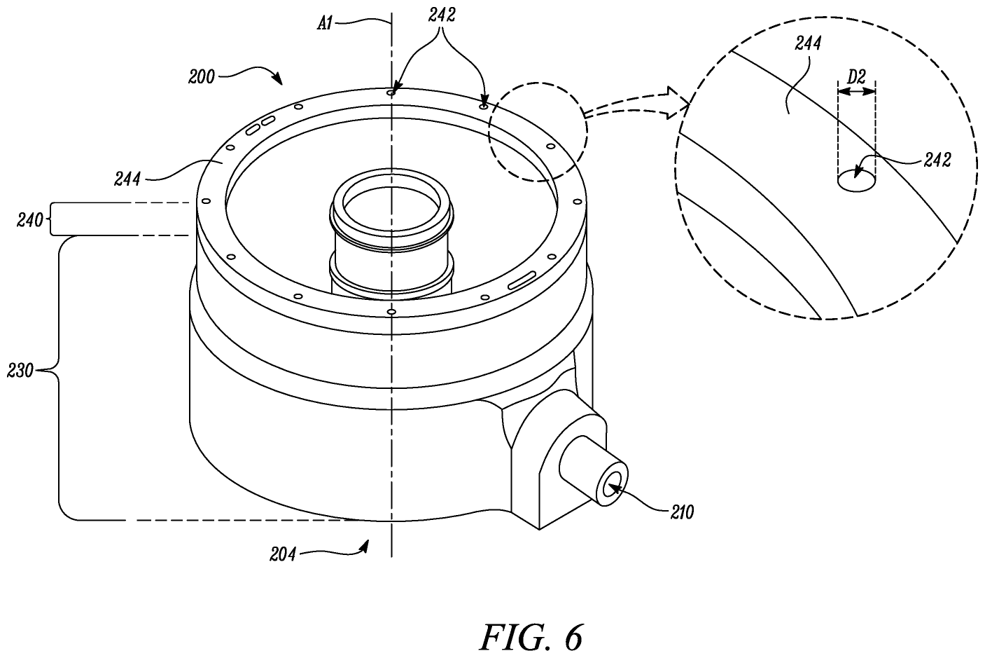

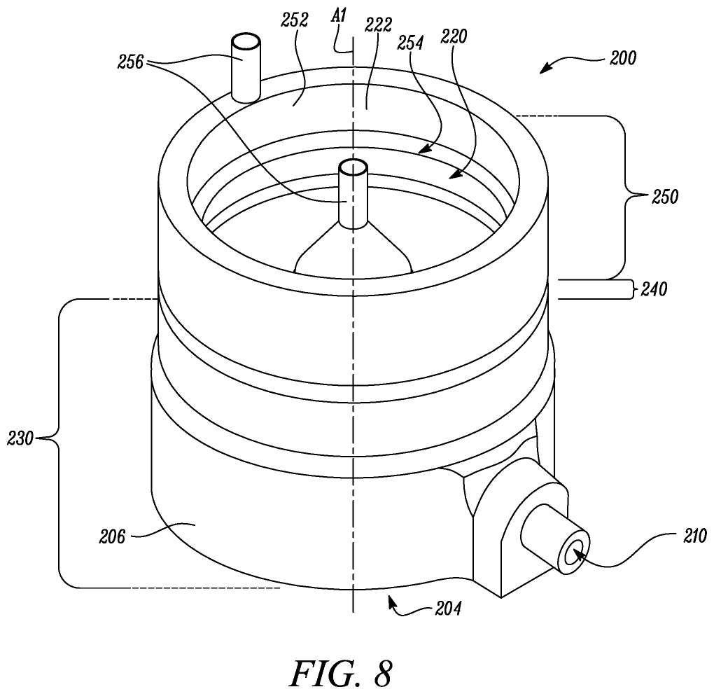

FIG. 6 illustrates a perspective view of the second section 240. The second section 240 of the FSN 200 is formed by ALM on the first section 230. The second section 240 includes at least one metering feature 242 disposed in fluid communication with at least one of the plurality of internal passageways 208 (shown in FIG. 4) of the first section 230. The metering features 242 are circumferentially defined around the central axis A1. In the illustrated embodiment of FIG. 5, the second section 240 includes multiple metering features 242, such that each metering feature 242 is in fluid communication with a corresponding internal passageway 208 of the first section 230. The second section 240 further includes a second surface 244 opposite the first surface 232 (see FIG. 4). The third section 250 (shown in FIG. 8) is formed on the second surface 244 of the second section 240. Each metering feature 242 may extend between the first surface 232 and the second surface 244. Each of the metering features 242 includes a desired diameter D2. In some embodiments, the desired diameter D2 of each metering feature 242 may be smaller than the desired diameter D1 of each internal passageway 208.

Further, in the illustrated embodiment of FIG. 6, the second surface 244 of the second section 240 is modified by a fourth subtractive manufacturing process prior to forming the third section 250 of the FSN 200. Specifically, the second surface 244 of the second section 240 may be modified by the fourth subtractive manufacturing process to obtain a desired surface roughness of the second surface 244 of the second section 240. The fourth subtractive manufacturing process may present a surface having a desired surface finish on which the third section 250 of the FSN 200 may be formed. In some embodiments, the fourth subtractive manufacturing process includes at least one of a milling process and a grinding process. In other embodiments, the fourth subtractive manufacturing process may include any other surface finishing process, without any limitation.

In some embodiments, the at least one metering feature 242 of the second section 240 is modified by a first subtractive manufacturing process to obtain the desired diameter D2 of the at least one metering feature 242 and/or a desired surface roughness of the at least one metering feature 242. The first subtractive manufacturing process is performed before formation of the third section 250. Thus, the desired diameter D3 may correspond to a diameter that may be larger than an initial diameter of each metering feature 242 prior to the modification made by the first subtractive manufacturing process.

Advantageously, modifying the metering features 242 by the first subtractive manufacturing process to obtain the desired surface roughness may reduce coking in the metering features 242. In other words, the surface roughness of the metering features 242 may be reduced by the first subtractive manufacturing process so that an amount of unburnt/burnt hydrocarbons of the fuel sticking to walls defined by the metering features 242 may be reduced. Further, the first subtractive manufacturing process may allow the metering features 242 to have precise dimensions and tolerances as per application requirements. Moreover, obtaining the desired diameter D2 of the metering features 242 may improve atomization and mixing of the fuel within the metering features 242.

In some embodiments, the first subtractive manufacturing process includes at least one of a drilling process, a hydro-erosive grinding (HEG) process, an electric discharge machining process, and the HCAF process. However, in other embodiments, the first subtractive manufacturing process may include any material removal process, without any imitation. In an example, the HCAF set-up 600 as explained in relation to FIG. 5 may be used to modify the metering features 242.

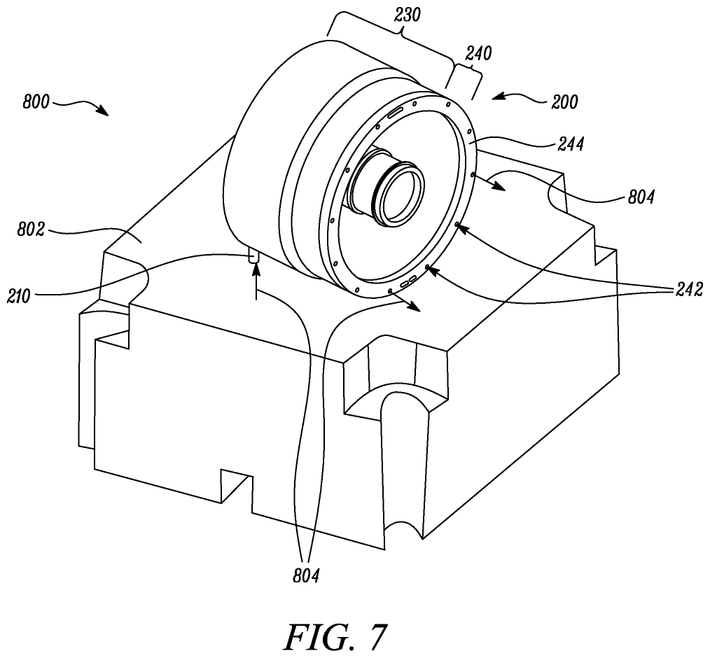

An exemplary HEG set-up 800 for performing the first subtractive manufacturing process is illustrated in FIG. 7. Specifically, the HEG set-up 800 is used to perform the HEG process on the second section 240. It should be noted that the HEG process as explained herein is merely for exemplary purposes. Any other subtractive manufacturing process may be used to modify the metering features 242 of the second section 240 in a similar manner.

FIG. 7 illustrates a perspective view of the HEG set-up 800. The HEG set-up 800 includes a fixture 802. In the illustrated embodiment of FIG. 7, the fixture 802 supports the first and second sections 230, 240 of the FSN 200. Further, an abrasive fluid (not shown) may be received within the inlet 210. Specifically, a fluid flow 804 of the abrasive fluid may first flow through the internal passageways 208 (shown in FIG. 4) before being received in the metering features 242. Thus, the fluid flow 804 may flow through the internal passageways 208 as well as the metering features 242.

While flowing through the second section 240, the fluid flow 804 may abrade the metering features 242 in the second surface 244. Specifically, the fluid flow 804 may modify the metering features 242 to obtain the desired diameter D2 of the metering features 242 and/or the desired surface roughness of the metering features 242. It should be noted that the fluid flow 804 may also modify the desired diameter D1 and the desired surface roughness of the internal passageways 208. In such examples, it may be contemplated that the desired diameter D1 of the internal passageways 208 after the first subtractive manufacturing process may be greater than the desired diameter D2 after the second subtractive manufacturing process. The fluid flow 804 may exit the second section 240 through the flow outlet 806. Alternatively, the first and second sections 230, 240 may be positioned on the fixture 802 such that the fluid flow 804 may first flow through the metering features 242 before being received in the internal passageways 208. In such examples, the fluid flow 804 may exit through the FSN 200 through the metering features 242. FIG. 8 illustrates a perspective view of the third section 250. The third section 250 of the FSN 200 is formed by ALM on the second section 240 to form the FSN 200. The third section 250 includes a deflector 220 and a spin chamber 222. The third section 250 includes the primary and secondary outlets 212, 214 (see FIG. 3). The deflector 220 may include feeding ports (not shown) that deliver the main fuel flow from the inlet 210 to the spin chamber 222. The feeding ports may provide a high angular velocity to the main fuel flow. Consequently, the fuel in the main fuel flow may spin in the spin chamber 222 after achieving a high angular velocity. The spinning of the fuel may create an internal swirling flow with high centrifugal force that may cause formation of an air-cored vortex in the spin chamber 222. As a result, the fuel of the main fuel flow may form a hollow conical spray (not shown) while exiting the spin chamber 222 from the primary outlet 212. In some embodiments, the fuel may travel from a nozzle orifice (not shown) to form the hollow conical spray.

In some embodiments, the FSN 200 may further include another spin chamber (not shown) that may be similar to the spin chamber 222. The spin chamber may be disposed proximal to the secondary outlet 214. The spin chamber may spin the fuel in the pilot fuel flow to form the hollow conical spray while exiting the spin chamber from the secondary outlet 214. The third section 250 may include a radially inner surface 252. The radially inner surface 252 includes a groove 254 that extends circumferentially about the central axis A1. The groove 254 may separate the deflector 220 and the spin chamber 222 of the FSN 200. In the illustrated embodiment of FIG. 8, the third section 250 further includes one or more expendable parts 256 that may be removed by a machining process after fabrication of the third section 250. The parts 256 may be removed by any conventional material removal process, such as, a milling process, a grinding process or a burr removal process.

The fabrication of fuel spray nozzles using the ALM process in a conventional manner may not enable access to the plurality of internal passageways 208 and the metering features 242 for performing one or more post-production processes. The FSN 200 described in the present disclosure may be manufactured in stages, at different instances of time. Specifically, in a first stage, the first section 230 may be formed by an additive manufacturing set-up (not shown). The first section 230 may then be removed from the additive manufacturing set-up for performing the second and third subtractive manufacturing processes on the first section 230. Further, in a second stage, the first section 230 may be positioned within the additive manufacturing set-up to form the second section 240. Furthermore, the first and second sections 230, 240 may be removed from the additive manufacturing set-up for performing the first and fourth subtractive manufacturing processes.

Moreover, in a third stage, the first and second sections 230, 240 may be again positioned within the additive manufacturing set-up to form the third section 250. By dividing the FSN 200 into the three sections, complex internal structures of the FSN 200, such as the internal passageways 208 and the metering features 242, may be easily fabricated and machined to achieve desired dimensions and/or surface roughness of the first and second sections 230, 240. Moreover, the FSN 200 as described herein may allow formation of complex passageways for fluid flow through the FSN 200 thereby optimising fuel flow through the FSN 200 and improving cooling performance of the FSN 200.

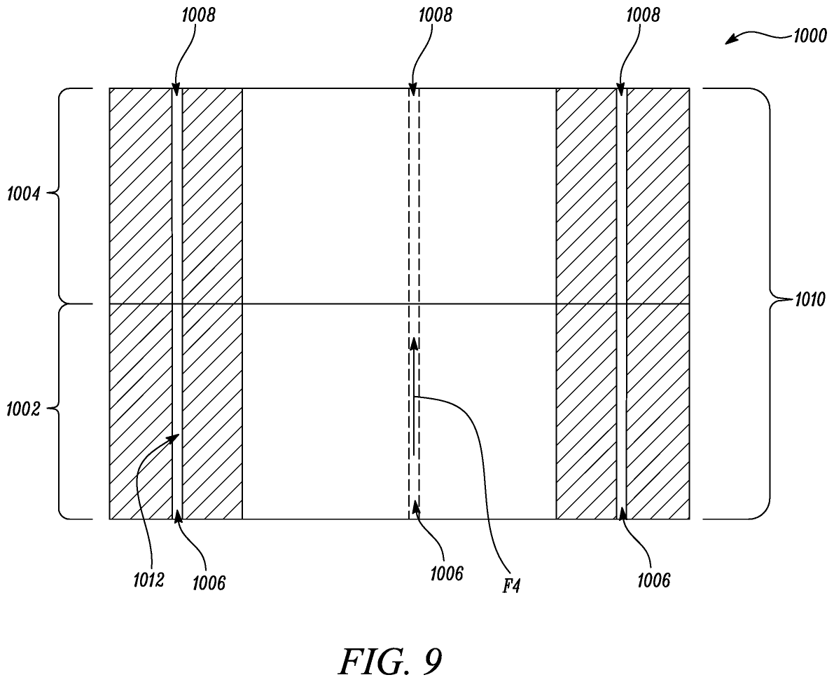

FIG. 9 illustrates a sectional schematic view of a FSN 1000, according to another embodiment of the present disclosure. The FSN 1000 may embody a simplex fuel spray nozzle, wherein only a single fuel flow circuit is defined in the FSN 1000. Thus, the FSN 1000 may eject a single spray of fuel, unlike the pressure-swirl duplex nozzle as explained in relation to FIGS. 2 to 8 that includes two fuel flow circuits, i.e., the main and pilot flow circuits. Further, only a portion of the FSN 1000 is illustrated in FIG. 9. It should be noted that the FSN 1000 illustrated in FIG. 9 is for explanatory purpose only, and the FSN 1000 may have any shape and/or design as per application requirements. The FSN 1000 may be substantially similar to the FSN 200 (see FIGS. 2 to 8) in terms of functionality. It should be noted that manufacturing details for the FSN 200 as explained in FIGS. 2 to 8 are equally applicable to the FSN 1000.

The FSN 1000 includes a first section 1002, a second section 1004, and a third section (not shown) that may be substantially similar to the first, second, and third sections 230, 240, 250, respectively, of the FSN 200. The first section 1002 includes a plurality of internal passageways 1006. Further, each passageway 1006 may be in fluid communication with a corresponding metering feature 1008 of the second section 1004 to form a flow passage 1010 for fuel to flow therethrough. In the illustrated embodiment of FIG. 9, the plurality of internal passageways 1006 of the first section 1002 forms a single flow circuit 1012. The single flow circuit 1012 may allow passage of a single fuel flow F4 through the FSN 1000. The single fuel flow F4 may be received within the FSN 1000 via an inlet (not shown) of the FSN 1000. Further, the fuel may flow through the internal passageways 1006 and the metering features 1008 before exiting the FSN 1000 via an outlet (not shown) of the FSN 1000.

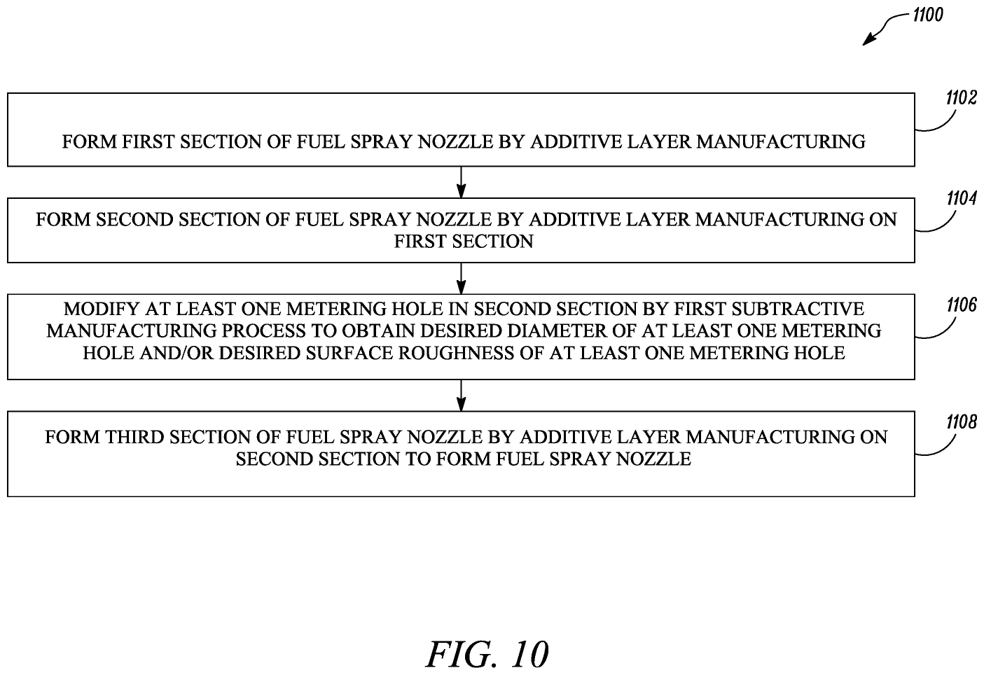

FIG. 10 illustrates a flowchart for a method 1100 for manufacturing the FSN 200 for the gas turbine engine 10. For exemplary purposes, the method 1100 will be explained in reference to the FSN 200 explained in relation to FIGS. 2 to 8. However, the method 1100 is equally applicable for manufacturing the FSN 1000 as shown in FIG. 9.

At step 1102, the method 1100 includes forming the first section 230 of the FSN 200 by ALM. The first section 230 of the FSN 200 includes the main chamber 206 and the plurality of internal passageways 208. At step 1104, the method 1100 includes forming the second section 240 of the FSN 200 by ALM on the first section 230. The second section 240 includes at least one metering feature 242 disposed in fluid communication with at least one of the plurality of internal passageways 208 of the first section 230.

At step 1106, the method 1100 includes modifying the at least one metering feature 242 of the second section 240 by the first subtractive manufacturing process to obtain the desired diameter D2 of the at least one metering feature 242 and/or the desired surface roughness of the at least one metering feature 242. The first subtractive manufacturing process includes at least one of a drilling process, a HEG process, an electric discharge machining process, and a HCAF process. Advantageously, modifying the surface roughness of the metering features 242 may improve performance of the FSN 200 and reduce coking. Further, the first subtractive manufacturing process may allow the metering features 242 to have precise dimensions and tolerances as per application requirements.

At step 1108, the method 1100 includes forming the third section 250 of the FSN 200 by ALM on the second section 240 to form the FSN 200. The third section 250 includes the deflector 220 and the spin chamber 222. The FSN 200 manufactured by the method 1100 may exhibit reduced coking and may also improve performance of the FSN 200. Further, the FSN 200 manufactured by the method 1100 may allow formation of complex passageways in the FSN 200 for fluid flow, thereby optimising fuel flow through the FSN 200 and improving cooling performance of the FSN 200.

In some embodiments, the method 1100 further includes, prior to forming the second section 240 of the FSN 200, modifying the plurality of internal passageways 208 of the first section 230 by the second subtractive manufacturing process to obtain the desired diameter D1 of each of the plurality of internal passageways 208 and/or the desired surface roughness of each of the plurality of internal passageways 208. In some embodiments, the second subtractive manufacturing process includes at least one of an abrasive flow machining process, a HCAF process, and a chemical etching process. Advantageously, modifying the surface roughness of each of the plurality of internal passageways 208 of the first section 230 may improve performance of the FSN 200 and reduce coking. Further, the second subtractive manufacturing process may allow the internal passageways 208 to have precise dimensions and tolerances as per application requirements.

In some embodiments, the method 1100 further includes, prior to forming the second section 240 of the FSN 200, modifying the first surface 232 of the first section 230 by the third subtractive manufacturing process. The second section 240 is formed on the first surface 232 of the first section 230. In some embodiments, the third subtractive manufacturing process includes at least one of a milling process, a grinding process, and a burr removal process. In some embodiments, the method 1100 further includes, prior to forming the third section 250 of the FSN 200, modifying the second surface 244 of the second section 240 by the fourth subtractive manufacturing process. In some embodiments, the fourth subtractive manufacturing process includes at least one of a milling process and a grinding process.

It will be understood that the invention is not limited to the embodiments above described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. A method for manufacturing a fuel spray nozzle for a gas turbine engine, the method comprising the steps of:
forming a first section of the fuel spray nozzle by additive layer manufacturing, the first section of the fuel spray nozzle comprising a main chamber and a plurality of internal passageways;
forming a second section of the fuel spray nozzle by additive layer manufacturing on the first section, the second section comprising at least one metering feature disposed in fluid communication with at least one of the plurality of internal passageways of the first section;
modifying the at least one metering feature of the second section by a first subtractive manufacturing process to obtain at least one of a desired diameter of the at least one metering feature or a desired surface roughness of the at least one metering feature; and
forming a third section of the fuel spray nozzle by additive layer manufacturing on the second section to form the fuel spray nozzle, the third section comprising a deflector and a spin chamber.

2. The method of claim 1, further comprising, prior to forming the second section of the fuel spray nozzle, modifying the plurality of internal passageways of the first section by a second subtractive manufacturing process to obtain at least one of a desired diameter of each of the plurality of internal passageways or a desired surface roughness of each of the plurality of internal passageways.

3. The method of claim 2, wherein the second subtractive manufacturing process comprises at least one of an abrasive flow machining process, a hydro-cavitation abrasive finishing process, and a chemical etching process.

4. The method of claim 1, further comprising, prior to forming the second section of the fuel spray nozzle, modifying a first surface of the first section by a third subtractive manufacturing process, whereof the second section is formed on the first surface of the first section.

5. The method of claim 4, wherein the third subtractive manufacturing process comprises at least one of a milling process, a grinding process, and a burr removal process.

6. The method of claim 1, further comprising, prior to forming the third section of the fuel spray nozzle, modifying a second surface of the second section by a fourth subtractive manufacturing process, wherein the third section is formed on the second surface of the second section.

7. The method of claim 6, wherein the fourth subtractive manufacturing process comprises at least one of a milling process, a grinding process, and a burr removal process.

8. The method of claim 1, wherein the first subtractive manufacturing process comprises at least one of a drilling process, a hydro-erosive grinding process, an electric discharge machining process, and a hydro-cavitation abrasive finishing process.

9. A fuel spray nozzle for a gas turbine engine, the fuel spray nozzle comprising:
a first section that has a main chamber and a plurality of internal passageways;
a second section formed on the first section, the second section comprising at least one metering feature disposed in fluid communication with at least one of the plurality of internal passageways of the first section; and
a third section formed on the second section to form the fuel spray nozzle, the third section comprising a deflector and a spin chamber;
wherein the fuel spray nozzle is a single unitary component with each of the first section, the second section and the third section being formed by additive layer manufacturing.

10. The fuel spray nozzle of claim 9, wherein the plurality of internal passageways of the first section forms a single flow circuit.

11. The fuel spray nozzle of claim 9, wherein the plurality of internal passageways of the first section forms a main flow circuit and a pilot flow circuit.

12. The fuel spray nozzle of claim 9, further comprising at least one inlet configured to receive a fuel flow, wherein the at least one inlet is disposed in fluid communication with each of the plurality of internal passageways of the first section.

13. A combustor for a gas turbine engine, the combustor including the fuel spray nozzle of claim 9.
